(19) United States
(12) Patent Application Publication
(10) Pub. No.: US 2010/0328514 A1
(43) Pub. Date: Dec. 30, 2010

(54) IMAGE PROCESSING DEVICE, IMAGING APPARATUS, AND THUMBNAIL IMAGE DISPLAYING METHOD

(75) Inventors: Takashi HOSOE, Kanagawa (JP); Atsushi Takeda, Seoul (KR); Hiroyasu Kunimi, Kanagawa (JP); Naoto Watanabe, Kanagawa (JP); Akifumi Matsushita, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/760,925

(22) Filed: Apr. 15, 2010

(30) Foreign Application Priority Data
Jun. 24, 2009 (JP) 2009-150135

(51) Int. Cl. H04N 5/222; G06K 9/36; G09G 5/00

(52) U.S. Cl. 348/333.05; 382/232; 345/634; 348/E05.024

(57) ABSTRACT

An imaging apparatus generates display data and index data. The display data includes compressed image data and thumbnail image data. The index data indicates the locations of the thumbnail image data in the display data. The imaging apparatus outputs the display data that is appended with the index data.

### CROSS-REFERENCE TO RELATED APPLICATIONS

This application is based upon and claims the benefit of priority from the prior Japanese Patent Application No. 2009-150135, filed on Jun. 24, 2009; the entire contents of which are incorporated herein by reference.

### BACKGROUND OF THE INVENTION

1. Field of the Invention

The present invention relates to an image processing device, an imaging apparatus, and a thumbnail image displaying method.

2. Description of the Related Art

Generally, an imaging apparatus including a solid-state image sensing device, such as a complementary metal-oxide semiconductor (CMOS) image sensor or a charged-coupled device (CCD) image sensor, outputs color signals corresponding to color filters arranged on the solid-state image sensing device in a time-sharing manner. The image signal that is obtained by capturing an image of a subject is output to the outside after being converted into an intended image format by a latter-stage signal processing unit. When, for example, the joint photographic experts group (JPEG) format is used as the image format, the signal processing unit in the imaging apparatus compresses the image signal in the JPEG format and outputs the JPEG format image data. Subsequently, in order to display the image, an image displaying device connected externally to the imaging apparatus decodes the JPEG format image data received from the imaging apparatus and converts that image data into a directly-displayable image format.

As an imaging apparatus, there exists a configuration that generates thumbnail image data obtained by reducing the size of an original image, superimposes the thumbnail image data on JPEG format image data, and then outputs the image data. A thumbnail image is displayed as, for example, an indexed image in an image displaying device (e.g., see Japanese Patent Application Laid-open No. 2007-248775).

Sometimes, an image displaying device displays a thumbnail image before decoding the JPEG format image data. Generally, thumbnail image data is divided into a plurality of data sets that are superimposed on the JPEG format image data. For example, markers are appended in advance at the start and at the end of the thumbnail image data and the data string of the thumbnail image data is extracted by detecting the markers. In such a case, in order to extract only the thumbnail image data from the JPEG format image data, the data output from the imaging apparatus is first stored in a memory on a temporary basis and then read therefrom in entirety. Hence, although the main object of using a thumbnail image is to provide a simplified display, displaying the thumbnail image takes a long time thereby making it difficult to achieve efficient image processing.

### BRIEF SUMMARY OF THE INVENTION

An image processing device according to an embodiment of the present invention comprises: an image compressing unit that compresses, in a predetermined format, an image signal obtained by capturing a subject image; a thumbnail image generating unit that generates thumbnail image data used in displaying a thumbnail image of the subject image; a display data generating unit that generates display data that includes compressed image data generated by the image compressing unit and the thumbnail image data generated by the thumbnail image generating unit; and an index data generating unit that generates index data indicating location of the thumbnail image data in the display data, wherein the image processing device outputs the display data that is appended with the index data.

An imaging apparatus according to an embodiment of the present invention comprises: an imaging unit that captures a subject image; an image compressing unit that compresses, in a predetermined format, an image signal that the imaging unit obtains by capturing the subject image; a thumbnail image generating unit that generates thumbnail image data used in displaying a thumbnail image of the subject image; a display data generating unit that generates display data including compressed image data generated by the image compressing unit and the thumbnail image data generated by the thumbnail image generating unit; and an index data generating unit that generates index data indicating location of the thumbnail image data in the display data, wherein the imaging apparatus outputs the display data that is appended with the index data.

A thumbnail image displaying method according to an embodiment of the present invention comprises: inputting display data that includes compressed image data that is formed by compressing, in a predetermined format, an image signal obtained by capturing a subject image and thumbnail image data that is used in displaying a thumbnail image of the subject image; appending, to the display data, index data that indicates location of the thumbnail image data in the display data; and extracting that includes referring to the index data appended to the display data and extracting, based on referred index data, the thumbnail image data from the display data.

### BRIEF DESCRIPTION OF THE DRAWINGS

FIG. 1 is a block diagram of an outline configuration of an imaging apparatus including an image processing device according to an embodiment of the present invention;

FIG. 2 is a schematic diagram for explaining an example of display data that is output by an output signal generating unit;

FIG. 3 is a schematic diagram for explaining an example of display data that is output by the output signal generating unit;

FIG. 4 is an explanatory diagram for explaining the details of index data; and

FIG. 5 is an explanatory diagram of an exemplary image size of an original image and exemplary image sizes of a thumbnail image.

### DETAILED DESCRIPTION OF THE INVENTION

Exemplary embodiments of an image processing device, an imaging apparatus, and a thumbnail image displaying method according to the present invention will be explained below in detail with reference to the accompanying drawings. The present invention is not limited to the following embodiments.

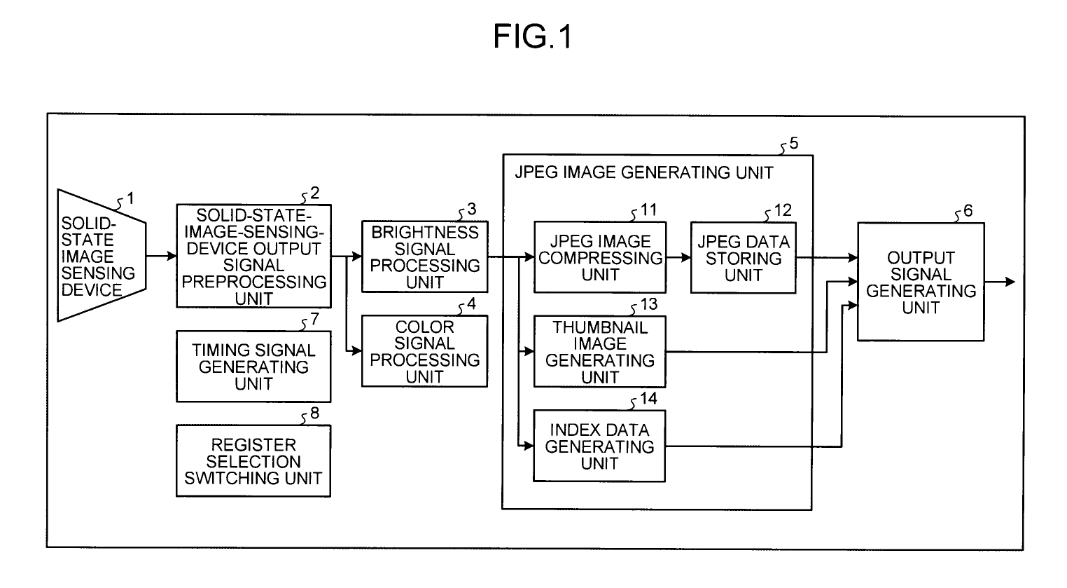

FIG. 1 is a block diagram of an outline configuration of an imaging apparatus including an image processing device according to an embodiment of the present invention. The imaging apparatus includes a solid-state image sensing device 1, a solid-state-image-sensing-device output signal preprocessing unit 2, a brightness signal processing unit 3, a color signal processing unit 4, a JPEG image generating unit 5, an output signal generating unit 6, a timing signal generating unit 7, and a register selection switching unit 8. Herein, the solid-state-image-sensing-device output signal preprocessing unit 2, the brightness signal processing unit 3, the color signal processing unit 4, the JPEG image generating unit 5, the output signal generating unit 6, the timing signal generating unit 7, and the register selection switching unit 8 constitute the image processing device that processes image signals output by the solid-state image sensing device 1.

As an imaging unit, the solid-state image sensing device 1 captures an image of a subject by converting the light from the subject into a signal charge. The timing signal generating unit 7 generates timing signals that are used in driving the solid-state image sensing device 1. The timing signals generated by the timing signal generating unit 7 are sent, as the standard for signal processing timings, to all constituent elements from the solid-state-image-sensing-device output signal preprocessing unit 2 to the register selection switching unit 8.

An image signal output by the solid-state image sensing device 1 is first input to the solid-state-image-sensing-device output signal preprocessing unit 2 and then input to the brightness signal processing unit 3 as well as the color signal processing unit 4. The solid-state-image-sensing-device output signal preprocessing unit 2, the brightness signal processing unit 3, and the color signal processing unit 4 respectively perform appropriate image processing on the image signal. A register setting value in each of the solid-state-image-sensing-device output signal preprocessing unit 2, the brightness signal processing unit 3, and the color signal processing unit 4 is either set externally or set internally in advance. The register selection switching unit 8 generates the register setting values and outputs them to the solid-state-image-sensing-device output signal preprocessing unit 2, the brightness signal processing unit 3, and the color signal processing unit 4, respectively. That enables determination of the content of image processing for each of the solid-state-image-sensing-device output signal preprocessing unit 2, the brightness signal processing unit 3, and the color signal processing unit 4.

The JPEG image generating unit 5 includes a JPEG image compressing unit 11, a JPEG data storing unit 12, a thumbnail image generating unit 13, and an index data generating unit 14. The JPEG image compressing unit 11 functions as an image compressing unit that compresses the image signal, which has been processed by the solid-state-image-sensing-device output signal preprocessing unit 2, the brightness signal processing unit 3, and the color signal processing unit 4, in the JPEG format and generates JPEG format stream data. The JPEG data storing unit 12 functions as a stream data storing unit that stores therein the stream data generated by the JPEG image compressing unit 11.

The thumbnail image generating unit 13 functions as a thumbnail image generating unit that generates thumbnail image data used in displaying a thumbnail image of an image of a subject. The thumbnail image data is generated from the image signal that is output by the solid-state image sensing device 1. The index data generating unit 14 functions as an index data generating unit that generates index data. The output signal generating unit 6 functions as a display data generating unit for generating the display data that is then output to an external device such as an image displaying device (not illustrated).

Upon being subjected to image processing, the image signal is input to the JPEG image compressing unit 11, the thumbnail image generating unit 13, and the index data generating unit 14. The JPEG image compressing unit 11 generates compressed image data by performing data compression of the image data according to the JPEG standard. The compressed image data is temporarily stored in the JPEG data storing unit 12 and then output to the output signal generating unit 6 based on a timing generated by the timing signal generating unit 7.

The register selection switching unit 8 generates the register setting value of the thumbnail image generating unit 13 on the basis of a setting value that is set in advance from outside. The thumbnail image generating unit 13 generates a thumbnail image according to the corresponding register setting value. For example, depending on the selection from outside, the register selection switching unit 8 generates the register setting value corresponding to the image size of a thumbnail image. The index data generated by the index data generating unit 14 represents the locations of the thumbnail image data within the display data that is output by the output signal generating unit 6. The index data generating unit 14 generates the index data according to the register setting value that the register selection switching unit 8 generates corresponding to the image size of a thumbnail image. Thus, in turn, the index data generating unit 14 generates the index data corresponding to the image size of a thumbnail image.

The JPEG image generating unit 5 outputs, at a predetermined timing, the compressed image data stored in the JPEG data storing unit 12, the thumbnail image data generated by the thumbnail image generating unit 13, and the index data generated by the index data generating unit 14. The output signal generating unit 6 generates the display data including the compressed image data, the thumbnail image data, and the index data that can be switched at predetermined timings, and then outputs the display data to the outside.

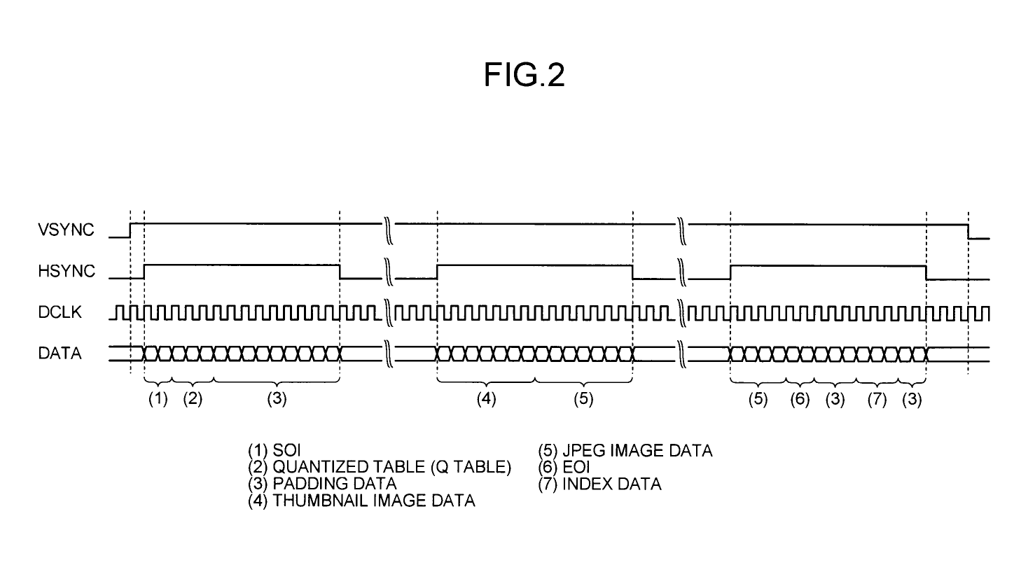

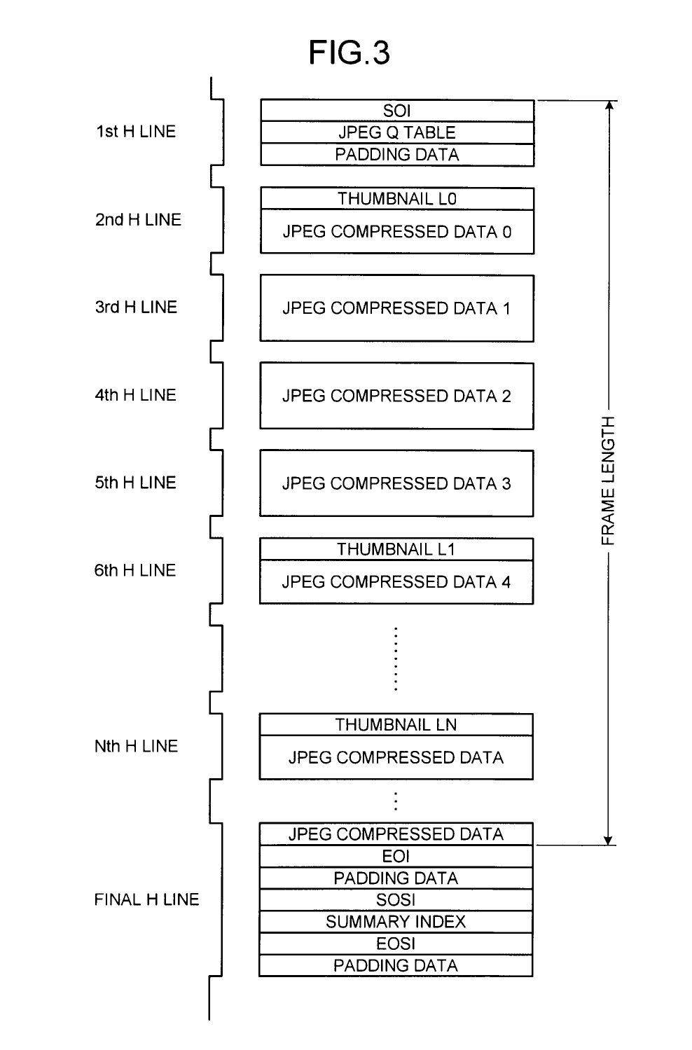

Given below is the detailed description about the output timing of the JPEG format image data. FIGS. 2 and 3 are schematic diagrams for explaining examples of display data that is output by the output signal generating unit 6. The output signal generating unit 6 outputs the display data based on a horizontal synchronizing signal HSYNC and a vertical synchronizing signal VSYNC generated by the timing signal generating unit 7. In FIG. 2, “DCLK” represents a timing signal generated by the timing signal generating unit 7, while “DATA” represents the display data output by the output signal generating unit 6.

Moreover, “SOI” stands for “start of image” and represents the code indicating the start of the display data. Thus, the SOI code is output at the start of the display data. Subsequent to the SOI code is output “QUANTIZED TABLE (Q TABLE)” that represents a data constellation used in decoding the compressed image data in the JPEG format (i.e., the JPEG format image data).

During a blanking period in the horizontal direction and the vertical direction (i.e., a period for which the horizontal synchronizing signal HSYNC or the vertical synchronizing signal VSYNC in FIG. 2 is “L”), outputting of the display data is discontinued. Moreover, during a data output period (i.e., a period for which the horizontal synchronizing signal HSYNC in FIG. 2 is “H”), if outputting of the whole compressed image data stored in the JPEG data storing unit 12 is complete and if no outputtable data is present, then “PADDING DATA” is output as dummy data until the start of the subsequent blanking period in the horizontal direction. For example, “0xFF” is output as “PADDING DATA”.

Herein, the premise is that a thumbnail image is generated with a smaller image size than the image size of the corresponding original image. The thumbnail image data is output in a discrete manner with respect to the timing at which the solid-state image sensing device 1 outputs the corresponding image signal. For example, in the case of generating a thumbnail image that is equivalent to one fourth of the size in the vertical direction of an original image captured by the solid-state image sensing device 1, thumbnail image data equivalent to a single line is output with respect to the output period of four lines in the image signal output by the solid-state image sensing device 1.

Consequently, as illustrated in FIG. 3, lines L0 to LN of the thumbnail image data are superimposed in the output period of a single line from among four lines of the compressed image data. Thus, the output signal generating unit 6 superimposes a single line of the thumbnail image data after every fourth output line of the compressed image data. In the output lines other than the output line on which the thumbnail image data is superimposed, either the JPEG data or the padding data is output. Upon completion of outputting the whole compressed image data and the thumbnail image data, “EOI” that stands for “end of image” is output as the code indicating that the data output is complete. Subsequently, the index data is output so that outputting of the display data is complete. Thus, the imaging apparatus according to the present embodiment outputs the display data that is appended with the index data.

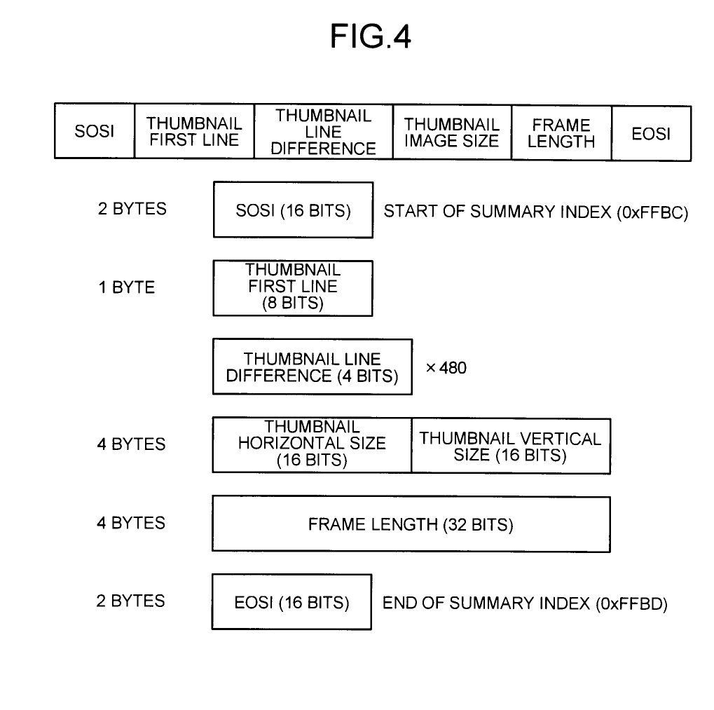

FIG. 4 is an explanatory diagram for explaining the details of the index data. At the start of the index data, “SOSI” that stands for “start of summary index” is output as the code indicating the start of the index data. To the “SOSI” code are allocated, for example, 16 bits (2 bytes). Subsequent to the SOSI code is output “THUMBNAIL FIRST LINE” that is location information of the location of that output line within a unit frame period on which the thumbnail image data is superimposed for the first time. To the “THUMBNAIL FIRST LINE” are allocated, for example, 8 bits (1 byte).

Subsequent to the “THUMBNAIL FIRST LINE” is output the number of bypassed lines between the output line on which the thumbnail image data is superimposed for the first time and the output line on which the thumbnail image data is superimposed for the second time. For example, if the thumbnail image data is output after every four output lines, then the number of bypassed lines is output as three. Similarly, for each of the subsequent output lines on which the thumbnail image data is superimposed, the number of bypassed lines is sequentially output.

“THUMBNAIL LINE DIFFERENCE” is the interval information indicating the number of bypassed lines, in other words, indicating the intervals between the output lines on which the thumbnail image data is superimposed. For example, if the size in the vertical direction of a generated thumbnail image is 480 lines, then 480 sets of data, each indicating the number of bypassed lines, are output. To each set of data are allocated, for example, 4 bits. When 4 bits are allocated to each set of data, the maximum value for the number of bypassed lines is set to 15.

The number of bits allocated to each set of data can be appropriately set depending on the minimum value in the vertical direction of a thumbnail image. Smaller the generated thumbnail image, greater is the number of bypassed lines. Hence, smaller the generable thumbnail image, greater is the number of bits allocated to each set of data indicating the number of bypassed lines.

Upon completion of outputting all sets of data in “THUMBNAIL LINE DIFFERENCE”, “THUMBNAIL IMAGE SIZE” is output that indicates the image size of the thumbnail image. The output of “THUMBNAIL IMAGE SIZE” includes output of “THUMBNAIL HORIZONTAL SIZE” indicating the number of lines in the horizontal direction and “THUMBNAIL VERTICAL SIZE” indicating the number of lines in the vertical direction. To each of “THUMBNAIL HORIZONTAL SIZE” and “THUMBNAIL VERTICAL SIZE” are allocated, for example, 16 bits. Thus, to “THUMBNAIL IMAGE SIZE” are allocated, for example, 32 bits (4 bytes).

Moreover, “THUMBNAIL IMAGE SIZE” is determined according to the register setting value generated by the register selection switching unit 8. Meanwhile, the value of “THUMBNAIL LINE DIFFERENCE” is determined based on the ratio of the image size of the original image and the image size of the thumbnail image specified in “THUMBNAIL IMAGE SIZE”.

Subsequent to “THUMBNAIL IMAGE SIZE” is output “FRAME LENGTH” that indicates the total number of lines of the output stream data. To “FRAME LENGTH” are allocated, for example, 32 bits (4 bytes). At the end of the index data, “EOSI” that stands for “end of summary index” is output as the code indicating the end of the index data. To the “EOSI” code are allocated, for example, 16 bits (2 bytes).

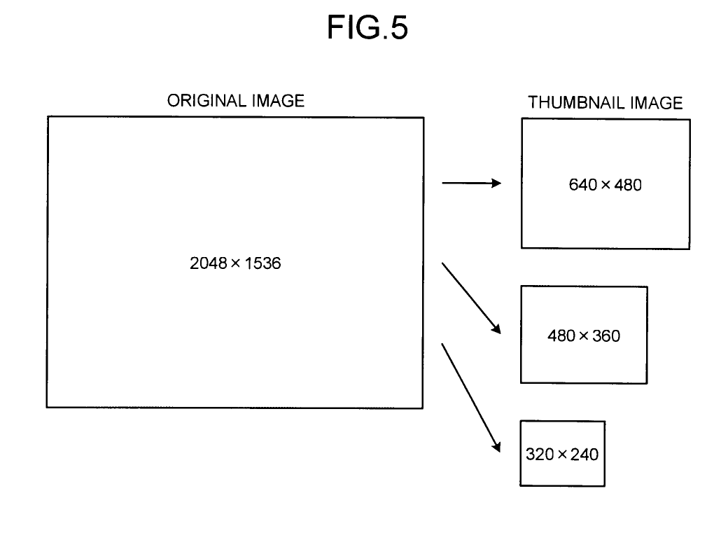

Given below is the explanation about the display of a thumbnail image. FIG. 5 is an explanatory diagram of an exemplary image size of an original image output by the solid-state image sensing device 1 and exemplary image sizes of a thumbnail image. Herein, the image size is represented with the number of pixels in the horizontal direction and the number of pixels in the vertical direction. The image size of the original image is, for example, 2048×1536 and depends on the number of pixels of the solid-state image sensing device 1. The image size of the thumbnail image needs to be smaller than the image size of the original image and can be arbitrarily set from outside. Moreover, the image size of the thumbnail image can be allowed to be changed. For example, in the present embodiment, an image size of the thumbnail image can be selected from image sizes of 640×480, 480×360, and 320×240.

At the time of displaying a thumbnail image, the image displaying device refers to the index data appended to the display data. More particularly, the image displaying device refers to “THUMBNAIL FIRST LINE” from among the index data and reads the location, within the display data, of the output line on which the thumbnail image data is superimposed for the first time. Then, the image displaying device refers to “THUMBNAIL LINE DIFFERENCE” and reads the locations of all output lines on which the thumbnail image data is superimposed. In this way, the image displaying device extracts the thumbnail image data from the display data by making use of the index data.

The display data output by an imaging apparatus is temporarily stored in an external memory unit such as a memory. Upon receiving that display data, an image displaying device decodes the JPEG format stream data and converts it into a directly-displayable image format. In some cases, before displaying an image by decoding the stream data, the image displaying device displays a thumbnail image. For example, there is a case when a thumbnail image is first displayed as a search image and selection of that thumbnail image by the user results in displaying the corresponding original image of the subject captured by the imaging apparatus.

In such a case, as compared to the process of decoding the JPEG format stream data and changing the image size, extracting the thumbnail image data superimposed on the display data enables achieving reduction in the time taken for displaying the thumbnail image. Generally, the thumbnail image data is superimposed on the display data in a discrete manner. If it is assumed that the thumbnail image data is extracted by detecting the markers appended at the start and at the end of the thumbnail image data; then, in order to extract the discretely-superimposed thumbnail image data, it becomes necessary to read the whole stream data stored in the memory unit.

In contrast, in the present embodiment, the location information regarding the thumbnail image data within the display data stored in the memory unit is obtained by reading the index data from a predetermined location, for example, from the end portion of the display data. With the use of the location information, it becomes possible to directly read only the thumbnail image data. For that reason, the thumbnail image data can be extracted by performing only a simple search. Moreover, since a simple search of the thumbnail image data is sufficient, it becomes possible to reduce the time taken for displaying the thumbnail images and achieve efficient processing of miniature circuits. Meanwhile, the location of the index data is not limited to the end portion of the display data. That is, the index data can be placed anywhere in the display data. For example, the index data can be placed close to the start of the display data.

Moreover, the display data output from the imaging apparatus can be output to any image displaying device that can display the image. Examples of the image displaying device include a digital camera, a personal computer, and a variety of handheld devices. Since the display data including “QUANTIZED TABLE (Q TABLE)” explained with reference to FIG. 2 is output to an image displaying device, the present embodiment is widely applicable with respect to conventional image displaying devices.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing device comprising:
an image compressing unit that compresses, in a predetermined format, an image signal obtained by capturing a subject image;
a thumbnail image generating unit that generates thumbnail image data used in displaying a thumbnail image of the subject image;
a display data generating unit that generates display data that includes compressed image data generated by the image compressing unit and the thumbnail image data generated by the thumbnail image generating unit; and
an index data generating unit that generates index data indicating location of the thumbnail image data in the display data, wherein
the image processing device outputs the display data that is appended with the index data.

2. The image processing device according to claim 1, wherein
the display data generating unit superimposes the thumbnail image data after every predetermined number-th output line of the compressed image data, and
the index data includes location information indicating location of an output line in the display data on which the thumbnail image data is superimposed for first time and interval information indicating intervals between output lines on which the thumbnail image data is superimposed.

3. The image processing device according to claim 1, wherein the index data generating unit generates the index data depending on an image size of the thumbnail image.

4. The image processing device according to claim 3, wherein
a register setting value is generated corresponding to the image size of the thumbnail image data, and
the index data generating unit generates the index data depending on the register setting value.

5. The image processing device according to claim 1, wherein the compressed image data, the thumbnail image data, and the index data are output at predetermined timings.

6. The image processing device according to claim 1, wherein the index data is output upon completion of outputting all of the compressed image data and the thumbnail image data within a unit frame period.

7. The image processing device according to claim 1, wherein
the image compressing unit generates stream data of the predetermined format, and
the image processing device further comprises a stream data storing unit that stores therein the stream data generated by the image compressing unit.

8. The image processing device according to claim 1, wherein the image compressing unit compresses the image signal in JPEG format.

9. An imaging apparatus comprising:
an imaging unit that captures a subject image;
an image compressing unit that compresses, in a predetermined format, an image signal that the imaging unit obtains by capturing the subject image;
a thumbnail image generating unit that generates thumbnail image data used in displaying a thumbnail image of the subject image;
a display data generating unit that generates display data including compressed image data generated by the image compressing unit and the thumbnail image data generated by the thumbnail image generating unit; and
an index data generating unit that generates index data indicating location of the thumbnail image data in the display data, wherein
the imaging apparatus outputs the display data that is appended with the index data.

10. The imaging apparatus according to claim 9, wherein
the display data generating unit superimposes the thumbnail image data after every predetermined number-th output line of the compressed image data, and
the index data includes location information indicating location of an output line in the display data on which the thumbnail image data is superimposed for first time and interval information indicating intervals between output lines on which the thumbnail image data is superimposed.

11. The imaging apparatus according to claim 9, wherein the index data generating unit generates the index data depending on an image size of the thumbnail image.

12. The imaging apparatus according to claim 11, wherein
a register setting value is generated corresponding to the image size of the thumbnail image data, and
the index data generating unit generates the index data depending on the register setting value.

13. The imaging apparatus according to claim 9, wherein the compressed image data, the thumbnail image data, and the index data are output at predetermined timings.

14. The imaging apparatus according to claim 9, wherein the index data is output upon completion of outputting all of the compressed image data and the thumbnail image data within a unit frame period.

15. The imaging apparatus according to claim 9, wherein
the image compressing unit generates stream data of the predetermined format, and
the imaging apparatus further comprises a stream data storing unit that stores therein the stream data generated by the image compressing unit.

16. The imaging apparatus according to claim 9, wherein the image compressing unit compresses the image signal in JPEG format.

17. A thumbnail image displaying method comprising:
inputting display data that includes compressed image data that is formed by compressing, in a predetermined format, an image signal obtained by capturing a subject image and thumbnail image data that is used in displaying a thumbnail image of the subject image;
appending, to the display data, index data that indicates location of the thumbnail image data in the display data; and
extracting that includes referring to the index data appended to the display data and extracting, based on referred index data, the thumbnail image data from the display data.

18. The thumbnail image displaying method according to claim 17, wherein the extracting includes extracting the thumbnail image data superimposed after every predetermined number-th output line of the compressed image data.

19. The thumbnail image displaying method according to claim 18, wherein
the index data includes location information indicating location of an output line in the display data on which the thumbnail image data is superimposed for first time and interval information indicating intervals between output lines on which the thumbnail image data is superimposed, and
the thumbnail image displaying method further comprises reading location of output lines on which the thumbnail data is superimposed by referring to the location information and the interval information.
